(19) United States
(12) Patent Application Publication
(10) Pub. No.: US 2025/0003286 A1
(43) Pub. Date: Jan. 2, 2025

(54) GLAZED PANEL DEVICE AND ASSOCIATED INSTALLATION METHOD

(71) Applicant: André Akerib, Mougins (FR)

(72) Inventor: André Akerib, Mougins (FR)

(21) Appl. No.: 18/694,321

(22) PCT Filed: Aug. 16, 2022
(86) PCT No.: PCT/EP2022/072857

§ 371 Date: Mar. 21, 2024

(30) Foreign Application Priority Data
Sep. 27, 2021 (FR) FR2II0120

(51) Int. Cl. E06B 3/67

(52) U.S. Cl. CPC E06B 3/6707; E06B 3/6715

(57) ABSTRACT

The present invention relates to a glazed panel device (1) for a building, comprising an outer glazed wall (2) and an inner glazed wall (3), a frame (4) for attaching the walls (2, 3) to a structure (100) of said building, providing a cavity (5) therebetween with said outer glazed wall (2) inclined with respect to a longitudinal median plane of said panel (1), said cavity (5) converging towards an edge (20) towards a communicating cell (6) and leading to an opening towards the outer wall (3), said cell (6) being provided with at least one acoustic insulation (60). The device is characterized in that it comprises at least one sound and/or heat shield, located in the upper and/or lower part of said frame (4), oriented towards the center of said device, according to a slope that flares out with respect to said longitudinal median plane of said panel (1).

### TECHNICAL FIELD

The present invention falls within the field of building construction and relates to a glazed panel device.

The invention will find its application in the installation of panels, in particular on a building facade, preferably of the curtain wall type.

It should be recalled that the generic term “curtain wall” corresponds to a lightweight facade, ensuring the closure of the envelope of a building, without participating in its load-bearing structure. A curtain wall comprises a plurality of independent walls intended to be interconnected by a reinforcement or “frame”, said frame being attached to the structure of the building.

More specifically, the invention specifically relates to a panel device whose walls are glazed, hereinafter also referred to as a “glazed panel”.

Currently, there is a wide variety of glazed panels, with different chassis and walls, depending on the construction to be carried out having to withstand numerous constraints, in particular related to bad weather such as rain and wind, earthquakes, fire and explosions, as well as air leakage in and out. Furthermore, the panels must ensure acoustic and thermal insulation, in order to limit sound nuisances as well as energy losses between the exterior and the interior of the building.

In this context, an existing glazed panel comprises at least two glazed walls, separated by a cavity.

### PRIOR ART

It will be noted that each glazed wall or “glazing” may be single, double, or triple with a plurality of windows spaced apart, or even laminated with a plurality of adjacent sheets. In the case of a double or triple glazing, the assembly of the windows makes it possible to obtain insulating features, in particular by the depressurization or the introduction of an inert gas within the hermetically sealed space located between the windows. A glazing may be reinforced, tempered, or laminated. Furthermore, a glazing may be transparent or translucent, tinted, or even opaque, or even reflective, due to treatment during the manufacture of the windows or of the glazing itself.

A glazed panel therefore comprises at least one outer wall, essentially subjected to climatic stresses, and an inner wall, in contact with the internal environment of the building, such as in particular heating and air-conditioning. The cavity makes it possible to compensate for the differences in behavior between the face walls at their respective stresses, serving as a separator buffer between the exterior and the interior of the building.

In particular, a known glazed panel comprises at least two outer and inner walls mounted so as to be attached onto the various elements of the frame, parallel to each other. In particular, the frame may comprise elements, attached to the structure of the building or between them, forming a spacer that ensures the glazings are parallel. Due to their being parallel, a glazed panel undergoes specific acoustic and thermal stresses, in particular on the basis of the incidence of the forces considered.

Firstly, considering the acoustic stresses experienced by the outer wall, the incident waves are likely to pass through the glazing and penetrate the cavity, generating a sound nuisance reflected on the inner wall. This penetration is all the greater when the incidence is normal relative to the outer face of the outer wall, which is often the case during a vertical installation of a glazed panel. In order to limit the sound level of this nuisance, the current solution consists in increasing the thickness of the windows of the outer wall, or even in adding windows, to attempt to attenuate the penetration. This results in a considerable extra cost, not only financially but also in terms of energy consumption at the time of manufacture. Furthermore, the panel is even heavier, requiring the chassis to be adapted accordingly.

In order to limit the angle of incidence from the outside, there is a glazed panel, the inner wall of which is inclined relative to the vertical outer wall, as described in document BE 676 258, the glazing of which comprises an inner glass pane inclined relative to a vertical outer glass pane. The cavity formed between the walls converges toward an inner side of said cavity, orienting the sound waves coming from the interior to that side. Therefore, an insulating material is placed along this side, directly or within a closed cell, ensuring the attenuation of the acoustic waves toward which they are directed and enclosed.

Furthermore, considering the thermal stresses, in the event of a significant difference in temperature between the interior and the exterior of the building, increasing the glazing remains a recommended solution, as is adding a thermal insulation arranged essentially on the perimeter of the cavity in the case of translucent glazing, or even breaking the thermal bridges between the elements of the frame supporting the outer wall and the inner wall. Taking these aspects into account considerably complicates the installation of glazed panels, thus increasing the corresponding costs.

In a connected manner, during the superposition of a plurality of glazings within the same panel, the cumulative mass requires increasing the resistance of the lower panels and, as such, the thickness of the glazed walls. In addition, the internal pressure applies a horizontal and transverse force at about one-third of the total height of the glazed panel. In order to keep the lower glazing from deforming, one solution therefore consists in distributing this load through the frame, which complicates the design and installation of such a panel.

### DESCRIPTION OF THE INVENTION

The purpose of the present invention is to overcome the disadvantages of the prior art by proposing to improve the behaviors between the outer and inner walls, particularly in their response to the acoustic and thermal stresses experienced by each of them.

To this end, the invention relates to a glazed panel device for a building, at least the outer wall of which has an incline relative to the longitudinal median plane of said panel. Firstly, this incline makes it possible to provide a cavity having a convergent section, the effect of which is to guide at least the acoustic waves passing through the outer wall towards an edge of the panel, as well as those coming from the interior.

Furthermore, said edge comprises a cell provided to communicate with the internal volume of the cavity between the outer and inner walls, and to emerge at an opening to the exterior. This open cell makes it possible to channel the acoustic waves, and also to attenuate them through a sound absorber installed at said cell.

Furthermore, in order to limit the penetration of the exterior waves through the open cell and to ensure that the waves channeled by the cavity and attenuated during their passage through the cell circulate towards the exterior, the invention advantageously provides for installing shields using a specific installation and design, attached to the exterior and/or the interior of the frame for attaching the outer and inner walls.

Thus, the invention may provide sound shields, in the outer part thereof, facing said opening of the cell. In addition, the specific installation and design of such sound shields ensure, on the one hand, an orientation of the acoustic waves when they are expelled from said cell and, on the other hand, a protection against external waves, in order to keep them from penetrating from the exterior to the interior of said cell. In addition, the orientation and the installation of the sound shields between them generates a vacuum zone, relative to the external incident waves, improving the extraction of the acoustic waves from the cell and the inside towards the outside.

Thus, alternatively or in combination, the invention may provide heat shields, in the inner part facing the lower part of the inner wall. In addition, the specific installation and design of such heat shields ensure the protection of the air coming from the interior of the room towards the loss surface of said inner wall, thus impacting the natural lift of the air flow along this inner wall.

Indeed, the invention takes into consideration the mass of the air in the room, which largely depends on the height of the room, inducing a horizontal force from the interior to the exterior, this force being essentially located in the lower third of said room, according to a transposition of the Coulomb theory of active pressure or “earth pressure”, often called a “Coulomb triangle”. This horizontal force applied to the mass of the air creates a horizontal flow in the lower part of the room, oriented toward the glazed panel.

Thus, when in position, a heat shield in the lower part and along the inner wall, the induced air flow is diverted, limiting heat losses in contact with said inner wall.

Furthermore, such heat shields also make it possible to reorient part of the sound waves coming from the interior of the room.

To do this, according to the invention, the glazed panel device for a building comprises
at least one outer glazed wall,
at least one inner glazed wall,
a frame for attaching said outer glazed wall and said inner glazed wall with a structure of said building, said attaching frame providing a cavity between said outer glazed wall and said inner glazed wall,
at least said outer glazed wall being inclined relative to a longitudinal median plane of said panel,
said cavity converging towards an edge of said panel,
at least one cell communicating with said cavity at said edge and leading to an opening towards the outer wall, said cell being provided with at least one acoustic insulation.

The device is characterized in that it comprises:
at least one sound and/or heat shield,
said at least one shield being installed at the upper and/or lower part of said frame,
said at least one shield being oriented towards the center of said device, according to a slope that flares out relative to said longitudinal median plane of said panel.

According to additional, non-limiting features, said cavity can be converging towards the upper edge of said panel.

According to one embodiment, said at least one shield comprises a profile with a section that flares out from an end for attaching to said frame, towards a distal end.

Said distal end may comprise a concave edge.

The device may comprise a sound shield installed externally and in the upper part of said frame, said attaching end being mounted on said frame, above the opening of the cell, said sound shield being oriented downwards, covering said opening.

Said sound shield may also comprise a diffuser, said diffuser being mounted on said frame, below the opening of said cell, said diffuser being oriented toward the distal end of said sound shield.

The device may comprise a heat shield being installed internally and in the lower part of said frame.

Said inner glazed wall can be vertical or inclined relative to the longitudinal median plane.

Said opening of the cell can be closed by a loss surface.

### BRIEF DESCRIPTION OF THE FIGURES

Other features and advantages of the invention will become apparent from the following detailed description of non-limiting embodiments of the invention, with reference to the appended figures, wherein:

FIG. 1 schematically shows a perspective view of an embodiment of a glazed panel device, installed at a facade of a building, in particular showing an inner wall and an outer wall inclined relative to said inner wall;

FIG. 2 schematically shows a view in vertical section of another embodiment of a glazed panel, in particular showing two superimposed outer walls and two superimposed inner walls, only the lower outer wall being inclined;

FIG. 3 schematically shows a view along a vertical section of an upper detail of an embodiment of a glazed panel, in particular showing, for an inclined outer glazed wall, the convergent end of the cavity leading to the cell, as well as a sound shield partially overlapping the opening of the cell;

FIG. 4 schematically shows a view similar to FIG. 3 of another embodiment of a glazed panel, in particular showing a cell according to another incline of the outer glazed wall relative to said inner glazed wall;

FIG. 5 schematically shows a view similar to FIG. 4 of another embodiment of a glazed panel, in particular showing a shield comprising a deflector;

FIG. 6 schematically shows a view along a vertical section of an upper detail of another embodiment of a glazed panel, in particular showing the two outer and inner glazed walls inclined relative to the vertically extending median plane; and

FIG. 7 schematically shows a view in vertical section of an upper detail of another embodiment of a glazed panel, in particular showing, for an outer glazed wall parallel to the median plane inclined relative to the vertical, the outer glazed wall inclined relative to said plane and relative to said inner glazed wall, also inclined, as well as a sound shield provided with a deflector with specific configurations;

FIG. 8 schematically shows a view along a vertical section of a lower detail of another embodiment of a glazed panel, in particular showing an outer wall inclined relative to a vertical inner wall, as well as a heat shield; and

FIG. 9 schematically shows a view along a vertical section of a lower detail of another embodiment of a glazed panel, in particular showing the outer and inner walls inclined relative to a vertical median plane.

### DETAILED DESCRIPTION OF THE INVENTION

The present invention relates to building construction and focuses on the installation of panels, in particular on a building facade, preferably of the wall-curtain type.

To this end, the invention relates to a building panel device 1.

Specifically, the invention targets a glazed panel device 1, hereinafter also referred to as a “device” or “glazed panel”.

Therefore, the device 1 comprises at least one outer glazed wall 2 and at least one inner glazed wall 3. In addition, the device 1 comprises an inner glazed wall 3 for each outer glazed wall 2. The walls 2, 3 are situated face-to-face, with their largest surfaces facing each other.

According to various embodiments, the device 1 may comprise a plurality of walls 2, 3, that are superimposed and/or contiguous, namely arranged respectively in columns or rows.

Preferably, the device 1 comprises an outer glazed wall 2 and an inner glazed wall 3, then forming a module with only two walls 2, 3.

Each of the walls 2, 3 may be a single glazing, a double or triple glazing with a plurality of windows spaced apart, or even laminated from several adjacent sheets. In the case of a double or triple glazing, the assembly of the windows makes it possible to obtain insulating features, in particular by the depressurization or the introduction of an inert gas within the hermetically sealed space located between the windows. A glazing may be reinforced, tempered, or laminated. Furthermore, a glazing may be transparent or translucent, tinted, or even opaque, or even reflective, due to treatment during the manufacture of the windows or of the glazing itself.

Thus, the device 1 may be a panel in the form of a double glazing, or even more, or else of which each of the walls 2, 3 are formed of a single, double or triple glazing. Furthermore, the walls 2, 3 may be identical or different, in particular with identical or different dimensions.

In addition, the device 1 comprises a frame 4, also referred to as a “reinforcement”. This frame 4 ensures the attachment of said at least one outer glazed wall 2 and said at least one inner glazed wall 3 with a structure 100 of said building. The frame 4 thus ensures the mechanical connection between the walls 2, 3, in particular their spacing. Said attaching frame 4 thus provides a cavity 5 between the outer glazed wall 2 and the inner glazed wall 3,

In addition, in the case of a panel 1 forming a double glazing, the frame 4 can form peripheral edges of said panel 1.

Such a frame may be solid or perforated. It comprises suitable elements and materials, ensuring good resistance between the walls 2, 3. Such elements may in particular be spars, angle irons, or brackets. These elements may be made of any type of material, in particular made of plastic, composite or preferably metal material.

In addition, the frame 4 makes it possible to attach the panel 1 to the structure 100 of the building, such as for example the floor, the underfloor, the walls or the ceiling, or even corresponding building elements.

Thus, the frame may comprise members shaped to, on the one hand, be subjected to the structure 100 and, on the other hand, to ensure the fastening of the panel 1, in particular of each of its walls 2, 3.

In particular, the frame 4 may comprise members 40 intended to receive the edges of the walls 2, 3.

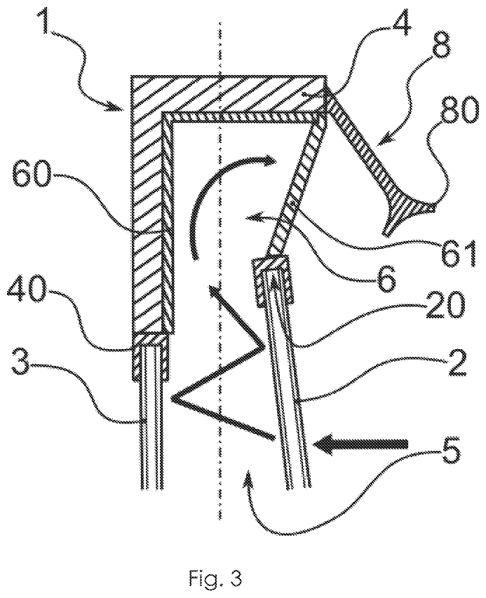

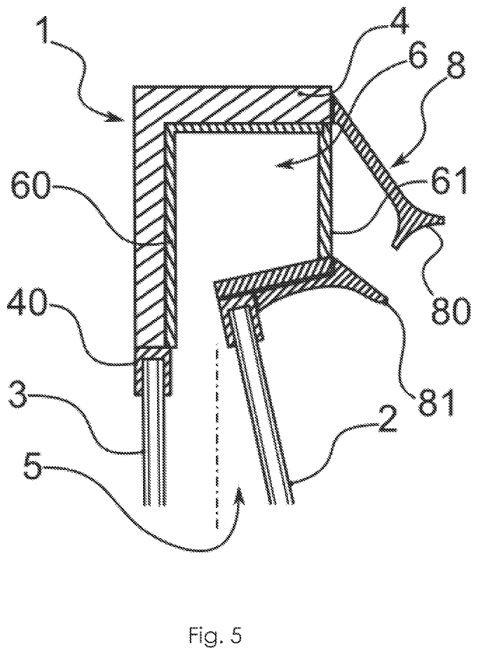

Examples of such members 40 are in particular shown in FIGS. 3 to 9. In such a case, the members 40 are in the form of U-shaped rails and sized to allow the insertion and retention of an edge of each wall 2, 3.

The frame 4 may also comprise other elements, in particular to connect a plurality of panels 1 to one another, or a plurality of outer glazed walls 2 to one another, or a plurality of inner glazed walls 3 to one another.

Advantageously, the invention provides for improving the performance of the panel 1 by inclining one of the walls 2, 3. In particular, the invention provides at least one incline of the outer 2 glazed wall 3 with respect to said panel 1. In brief, the walls 2, 3 are not parallel to one another.

Furthermore, the inclining of the outer 2 glazed wall 3 relative to said panel 1 makes it possible either to keep heat inside the room, or to leave heat out of the room and thus to cool it. The incline of the outer glazed wall 2 also improves the acoustic insulation of said panel 1.

This limitation of heat loss, this room heating, or this room cooling makes it possible to achieve considerable energy savings.

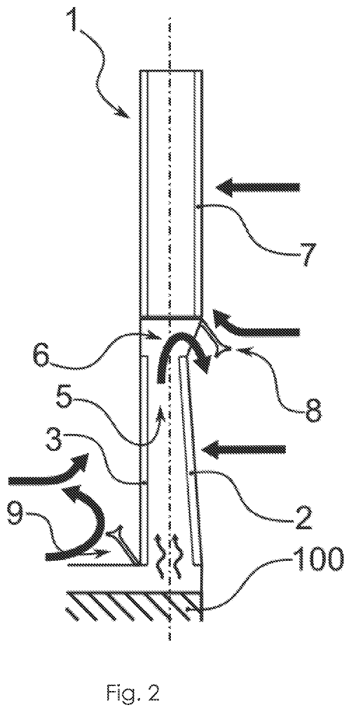

Preferably, the panel 1 is characterized in that said outer 2 glazed wall 3 is inclined relative to said longitudinal median plane of said panel 1. Such a median plane is shown schematically in dashed lines in FIGS. 2 to 9. Such a plane extends along the length, namely the longest axis, of said panel 1. This plane also passes through the center of said panel 1, which gives it its median nature. According to the examples shown in the Figures, said median plane extends vertically.

More specifically, according to one embodiment, the outer glazed wall 2 is inclined relative to the inner glazed wall 3. FIGS. 3 to 5 show different embodiments, where the inner glazed wall 3 extends vertically, in parallel with respect to said median vertical plane, while the outer glazed wall 2 is inclined in a manner converging towards said inner glazed wall 3, with an upward convergence.

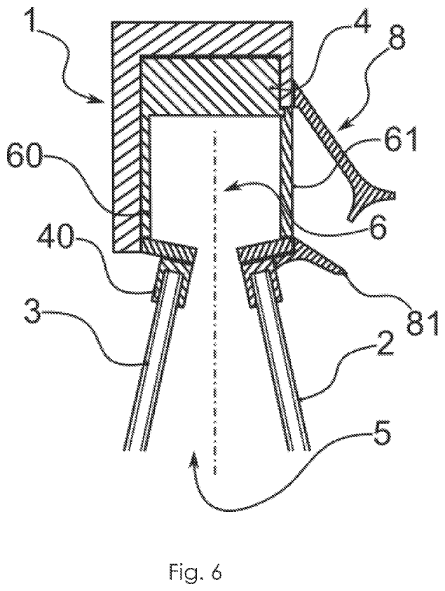

According to another embodiment, the walls 2, 3 are inclined relative to the longitudinal median plane of the panel 1. FIG. 6 shows an embodiment, where the walls 3, 4 are both inclined, in particular symmetrically with respect to the median plane. In brief, the angle of incline of the outer glazed wall 2 is equal or substantially equal to the angle of incline of the inner glazed wall 3. The panel 1 then has a cavity 5 with a trapezoidal cross-section, forming a funnel.

According to another possibility, the walls 2, 3 can be inclined asymmetrically relative to the median plane, namely their respective angle of incline is different relative to said plane.

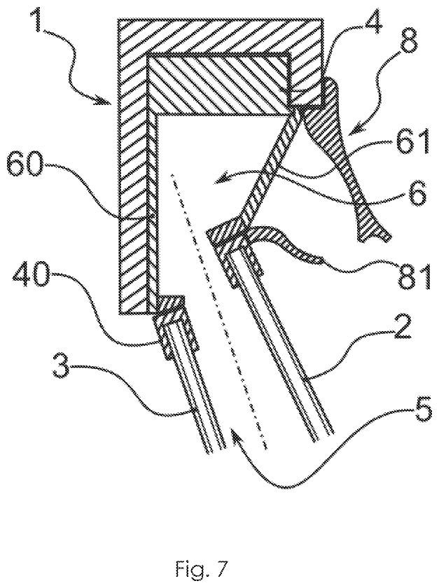

According to yet another embodiment, it is the entire panel 1 that has an incline, namely that its median plane is not vertical. Therefore, one and/or the other of the walls 2, 3 can be inclined relative to said axis. FIG. 7 shows a configuration where the inner glazed wall 3 is parallel to the median plane of the panel 1, itself inclined relative to the vertical, while the outer glazed wall 2 is inclined relative to said median plane, and consequently relative to said inner glazed wall 3.

In addition, said at least one outer glazed wall 2 and/or said at least one inner glazed wall 3 is securely mounted by said frame 4 at an incline of between three degrees and thirty degrees relative to said at least one outer glazed wall 2.

According to various embodiments, said incline may be 5, 7.5, 10, 15, 20 or 25 gradians.

It will be recalled that a gradian corresponds to 0.9 degrees. Under such circumstances, the incline may be:
5 gradians, i.e. 4.5 degrees;
7.5 gradians, i.e. 6.75 degrees;
10 gradians, i.e. 9 degrees;
15 gradians, i.e. 13.5 degrees;
20 gradians, i.e. 18 degrees; or
25 gradians, i.e. 22.5 degrees.

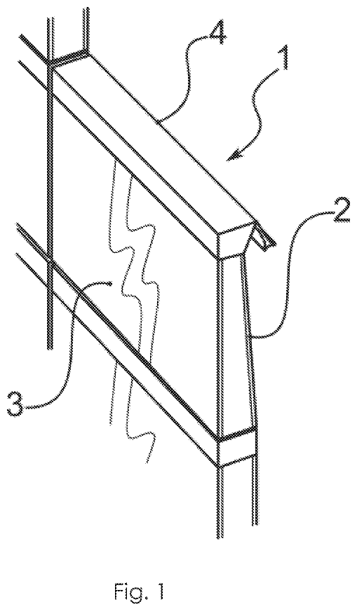

Therefore, said cavity 5 converges towards an edge of the panel 1, as can be seen in FIG. 1.

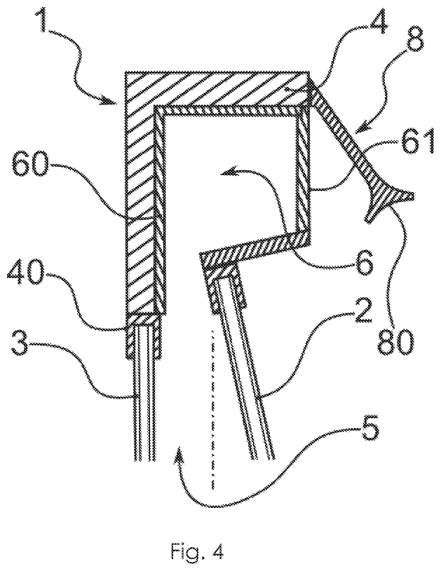

As can be seen in the embodiments shown in FIGS. 3 and 4, the cavity converges towards an edge of said at least one outer glazed wall 2, preferably the upper edge 20.

As can be seen in the Figures, the cavity 5 is oriented convergent toward an edge of said at least one outer glazed wall 2, preferably its upper edge 20.

As can be seen in FIG. 6, the cavity 5 is oriented convergent toward the adjacent edges of said at least one outer glazed wall 2 and said at least one inner glazed wall 3, in particular their respective upper edge.

Such an orientation makes it possible to orient any flow entering the cavity 5 from the outside by passing through the outer glazed wall 2, in particular an acoustic wave. In particular, as shown in FIG. 3, a wave that strikes the outer face of the outer glazed wall 2, in particular with an incidence normal to said outer wall 2, can pass through it in a reduced way and bounce against the inclined inner face of the inner glazed wall 3, in order to be guided in the convergent direction of the cavity 5, until it reaches the edge 20 of the outer wall 2. In brief, the acoustic wave is directed toward one side of the panel 1, instead of stressing the inner glazed wall 3.

Furthermore, the incline of the outer glazed wall 2 (combined or not with the incline of the inner wall 3) makes it possible to limit, or even cancel, the generating of parasitic oscillations, originating in particular from the combination by covering a plurality of successive incident acoustic waves, such as reverberations or echoes.

Further ahead, the edge 20 may be equipped with means ensuring the absorption of the acoustic wave thus channeled.

To do this, advantageously, the panel device 1 comprises at least one cell 6 communicating with said cavity 5 at said edge 20. Furthermore, as can be seen in the embodiments shown in FIGS. 2 to 7, the cell 6 is shaped to connect the walls 2, 3 to the levels of the edge 20 of the inner glazed wall 3 and the corresponding edge of the outer glazed wall 2. The cell 6 is generally rectangular in shape or trapezoidal prism, open on one side located at the convergent side of the cavity 5.

Preferably, as can be seen in FIGS. 3 to 7, the cell 6 has a spacing section wider than the spacing section of the cavity 5 at its convergent end. This narrowing of the cavity 5 followed by a widening formed by the cell 6 generates a so-called “Venturi” effect, guiding and accelerating the flows, such as the acoustic waves carried by the air, along the cavity 5 in its convergent direction, and then expanding said flows within the cell 6.

In particular, due to the fact that the cavity 5 communicates directly with the cell 6, the air and the acoustic waves are guided along the convergent slope, circulating freely without obstacles, in order to be channeled and retained in the cell 6 with a view to their being attenuated. Furthermore, this opening communication limits any overpressure effect between the walls 2, 3, in particular during the circulation of a sound wave.

The acoustic wave is therefore guided by the convergence of the cavity 5, and therefore penetrates into the cell 6. In addition, said cell 6 is provided with at least one acoustic insulation 60, making it possible to attenuate the sound power of the acoustic wave that passes through said cell 6. In brief, the acoustic insulation 60 is situated inside the cell 6.

Such acoustic insulation can be a covering made of a suitable material, capable of absorbing certain frequencies of an acoustic wave.

In addition, according to the invention, the cell 6 leads to an opening towards the outer wall (3). In particular, such a cell 6 may comprise a permeable side 61, in order to allow air circulation, while canceling certain frequencies of the residual acoustic wave that have passed through said cavity 5. Thus, the cell 6 acts as a trap, collecting the acoustic waves to enclose them therein, while allowing the air to circulate between the cell 6 and the exterior of the building.

According to one embodiment, said opening of the cell (6) is closed by a loss surface. That surface may be made of any type of material, permeable to acoustic waves, but at least partially ensuring their attenuation.

According to one embodiment, as can be seen in FIG. 2, the panel device 1 comprises at least one additional outer glazed wall 7 superimposed on said at least one outer glazed wall 2. In addition, said at least one additional outer glazed wall 7 is oriented parallel to said at least one inner glazed wall 3. In brief, only the outer glazed wall 2, located below, is inclined. Furthermore, according to the configuration shown in FIG. 2, the cell 6 can be positioned between the edge 20 of the outer glazed wall 2 located below and the lower edge of said additional glazed wall 7 located above. According to another configuration, the upper edge 20 of the outer glazed wall 2 leads to the lower edge of the additional glazed wall 7 and the cell 6 is then offset and positioned in communication with the upper opposite edge of this additional glazed wall 7.

According to another embodiment, not shown, the additional glazed wall 7 is also inclined, at a degree of incline similar or identical to the outer glazed wall 2. In this case, the additional wall 7 may also comprise a corresponding additional cell, in particular at its upper edge.

From a thermal point of view, advantageously, the incline of at least the outer glazed wall 2 ensures better circulation of the heat flows circulating inside the room where the panel device 1 is installed. The example of FIG. 2 highlights a circulation of the heat flows, shown by a left arrow, in particular under the action of heating or air conditioning means present within said room. These flows are turbulent but have a generally rotary direction, so that they slide along the inner face of the inner glazed wall 3 that is inclined in this case, instead of pushing against it in the case of a vertical wall.

Indeed, depending on the degree of incline of the inner glazed wall 3, the invention makes it possible to modify the incidence of the thrust force generated horizontally towards the inner glazed wall 3. In particular, such a thrust force is generated due to a thermal attraction, in particular in the case of a temperature difference greater than 2 degrees Celsius (C) measured between said wall 3 and the environment of the room. The incline of said wall 3 means that this force no longer thrust the mobile heat flow of the room normally, but with an angle, which reduces losses through said fixed inner glazed wall 3.

In addition, the thrust towards the inner wall 3 results from the mass of the air, according to Coulomb theory, inducing a horizontal force in the lower third of the room, coming to press against said inner wall 3. Because of the incline of the outer wall 2, combined or not with the incline of the inner wall 3, this Coulomb induced force is reoriented, modifying the flow conditions of the air inside the room, thus improving thermal insulation.

The invention thus makes it possible to achieve an improvement from a thermal insulation perspective.

That said, in order to improve the sound and/or heat insulation already acquired due to the incline of at least the outer wall 2, the invention provides for installing sound shields 8 and/or heat shields 9, respectively.

To do this, the glazed panel device 1 comprises at least one sound shield 8 and/or at least one heat shield 9.

In addition, said at least one shield 8, 9 comprises a profile. Such a profile extends along the width of the panel 1. Said profile may be made of any type of material, preferably plastic, metal or composite.

Furthermore, said profile has a section that flares out from an end for fastening to said frame 4, towards a distal end 80, 90. In brief, the profile of the shield 8, 9 is thicker at its free end than at its attaching end on the panel 1.

Said edge of the distal end 80, 90 may be of any shape.

According to one embodiment, as can be seen in FIGS. 3 to 9, said distal end 80, 90 comprises a concave edge. The section of the shield 8, 9 is then generally the shape of a golf tee.

Regarding sound insulation, the device 1 comprises a sound shield 8 installed externally and in the upper part of said frame 4.

In addition, said attaching end is mounted on said frame 4, above the opening of the cell 6.

Furthermore, said sound shield 8 is oriented downwards, covering said opening.

Under such circumstances, the sound shield 8 makes it possible to deflect part of the acoustic waves coming from the outside, protecting the opening of the cell 6. This deviation makes it possible to limit the acoustic waves likely to penetrate into the cell 6 via its opening, ensuring that the waves channeled from the interior of the panel 1 propagate and emerge attenuated by said opening. This deviation and the channeling of the sound waves is in particular represented by corresponding arrows in FIG. 2.

According to one embodiment, said sound shield 8 comprises a diffuser 81. A plurality of examples of a sound shield 8 with a diffuser 81 are shown in FIGS. 3 to 7.

In addition, said diffuser 81 is mounted on said frame 4, below the opening of said cell 6. In brief, the diffuser 81 is another profile, attached under the profile of the sound shield 8, or connected at regular intervals with the profile of said sound shield 8, through a perforated structure.

Said profile of the diffuser 81 may have any shape, in particular with a hollow or concave lower edge, as can be seen in FIGS. 6 to 7.

In addition, said diffuser 81 is oriented toward the distal end of said sound shield 8. In brief, the diffuser 81 outwardly forms a tooth, limiting the raising of the acoustic waves along the outer wall 22 and preventing their penetration into the cell 6 via its opening.

According to a preferred embodiment, shown in FIG. 7, the sound shield 8, as well as its diffuser 81, comprise profiles with specific rounded shapes, improving the flow of the acoustic waves.

In a related manner, the sound shield 8 also makes it possible to limit the penetration of air flow from the outside to the inside of the cell 6, limiting heat losses in this direction.

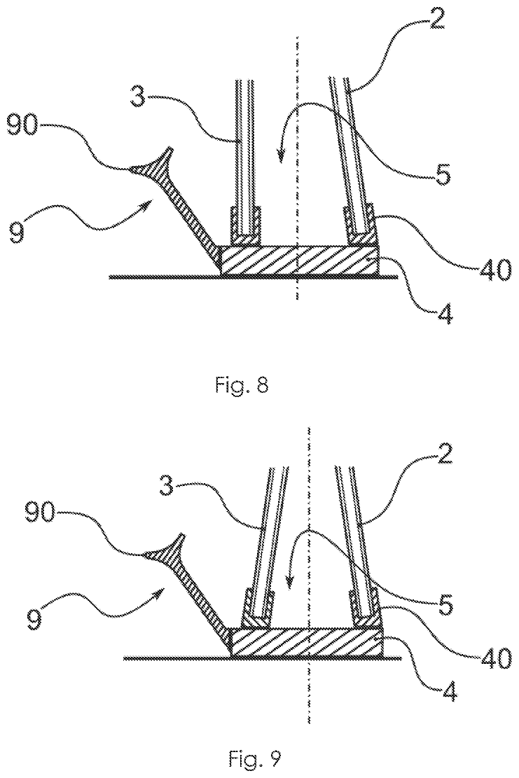

In this respect, regarding thermal insulation, the device 1 comprises a heat shield 9 installed internally and in the lower part of said frame 4. Like the sound shield 8, the heat shield 9 is therefore oriented toward the center of the device 1, flaring out from its attaching end with the frame 4 toward its distal end 90. In brief, the heat shield 9 is turned upward, forming overall a V-shape with the inner wall 3 at the base of the glazed panel 1, as can be seen in the two embodiments of FIGS. 8 and 9.

Furthermore, the heat shield 9 comprises a profile which can have a shape and a cross-section similar to that of the profile of the sound shield 8.

Therefore, due to its configuration, the heat shield 8 makes it possible to push back, from the base of the panel 1, the flow of air coming from the inside of the room, in particular induced by the horizontal force resulting from the Coulomb theory. As modeled in FIG. 2, the air is deflected inwards, making it possible to divert the rest of the air flow located above. Thus, the contact of the air that is stirred in this way with the inner wall 3 is disrupted, limiting heat losses. Furthermore, this disruption thus generated makes it possible to deflect the internal acoustic waves and to limit their transmission to the inner wall 3 of said panel 1.

According to one embodiment, the panel device 1 comprises at least one heating or cooling member of said cavity 5. Such a heating or cooling member can be connected to a dedicated and independent means, relative to the building, in particular in the room where one or several panels 1 of panels are installed. Furthermore, the heating or cooling member may open at one of the edges of the cavity 5, with a view to ensuring the circulation of a heated or cooled flow from said dedicated means.

The example of FIG. 2 highlights a heating flow circulating toward the cavity 5 via said heating or cooling member, then located in the lower position of said panel 1, at the junction with the structure 100 of the building.

Furthermore, from a structural point of view, the incline of at least the outer glazed wall 2, in particular in the lower position of a panel 1, makes it possible to considerably lighten the structure of the curtain wall, composed of one or several superimposed panels 1. Indeed, the incline reflects upward the force coming from the combined mass of the panels 1 and/or outer glazed walls 2 superimposed on it. It is then possible to reduce the strength of the materials, in particular to reduce the thickness and the weight of the corresponding glazings.

Thus, through its glazed panel device 1, the invention makes it possible to improve the acoustic and thermal performance of the curtain wall attached to a building, while offering a lightened total mass for the materials used.

1. A glazed panel device (1) for a building, comprising:
at least one outer glazed wall (2),
at least one inner glazed wall (3),
a frame (4) for attaching said outer glazed wall (2) and said inner glazed wall (3) to a structure (100) of said building, said frame (4) forming a cavity (5) between said outer glazed wall (2) and said inner glazed wall (3),
at least said outer glazed wall (2) being inclined relative to a longitudinal median plane of said panel (1),
said cavity (5) converging towards an edge (20) of said panel (1),
at least one cell (6) communicating with said cavity (5) at said edge and leading to an opening towards the outer wall (2), said cell (6) being provided with at least one acoustic insulation (60),
characterized in that it comprises:
at least one sound and/or thermal shield (8, 9),
said at least one shield (8, 9) being installed at the upper and/or lower part of said frame (4),
said at least one shield (8, 9) being oriented toward the center of said device (1), according to a slope that flares out relative to said longitudinal median plane of said panel (1).

2. The glazed panel device (1) according to claim 1, characterized in that said cavity (5) converges toward the upper edge of said panel (1).

3. The glazed panel device (1) according to claim 1, characterized in that said at least one shield (8, 9) comprises a profile with a section that flares out from an end for attaching to said frame (4), toward a distal end (80, 90).

4. The glazed panel device (1) according to claim 3, characterized in that said distal end (80, 90) comprises a concave edge.

5. The glazed panel device (1) according to claim 3, characterized in that it comprises
a sound shield (8) installed externally and in the upper part of said frame (4),
said fastening end being mounted on said frame (4), above the opening of the cell (6),
said sound shield (8) being oriented downward, covering said opening.

6. The glazed panel device (1) according to claim 5, characterized in that
said sound shield (8) comprises a diffuser (81),
said diffuser (81) being mounted on said frame (4), below the opening of said cell (6),
said diffuser (81) being oriented toward the distal end (80) of said sound shield (8).

7. The glazed panel device (1) according to claim 1, characterized in that it comprises a heat shield (9) being implanted internally and in the lower part of said frame (4).

8. The glazed panel device (1) according to claim 1, characterized in that said inner glazed wall (3) is vertical or is inclined relative to the longitudinal median plane.

9. The glazed panel device (1) according to claim 1, characterized in that said opening of the cell (6) is closed by a loss surface.
